(19) United States
(12) Patent Application Publication
(10) Pub. No.: US 2022/0121853 A1
(43) Pub. Date: Apr. 21, 2022

(54) SEGMENTATION AND TRACKING SYSTEM AND METHOD BASED ON SELF-LEARNING USING VIDEO PATTERNS IN VIDEO

(71) Applicant: ELECTRONICS AND TELECOMMUNICATIONS RESEARCH INSTITUTE, Daejeon (KR)

(72) Inventors: Jin Hee SON, Daejeon (KR); Sang Joon PARK, Sejong-si (KR); Blagovest Iordanov Vladimirov, Changwon-si (KR); So Yeon LEE, Sejong-si (KR); Chang Eun LEE, Daejeon (KR); Jin Mo CHOI, Daejeon (KR); Sung Woo JUN, Daejeon (KR); Eun Young CHO, Daejeon (KR)

(73) Assignee: ELECTRONICS AND TELECOMMUNICATIONS RESEARCH INSTITUTE, Daejeon (KR)

(21) Appl. No.: 17/505,555

(22) Filed: Oct. 19, 2021

(30) Foreign Application Priority Data
Oct. 19, 2020 (KR) 10-2020-0135456

(51) Int. Cl. G06K 9/00; G06K 9/62

(52) U.S. Cl. CPC G06K 9/00718; G06K 9/6262; G06K 9/00744

(57) ABSTRACT

Provided is a segmentation and tracking system based on self-learning using video patterns in video. The present invention includes a pattern-based labeling processing unit configured to extract a pattern from a learning image and then perform labeling in each pattern unit to generate a self-learning label in the pattern unit, a self-learning-based segmentation/tracking network processing unit configured to receive two adjacent frames extracted from the learning image and estimate pattern classes in the two frames selected from the learning image, a pattern class estimation unit configured to estimate a current labeling frame through a previous labeling frame extracted from the image labeled by the pattern-based labeling processing unit and a weighted sum of the estimated pattern classes of a previous frame of the learning image, and a loss calculation unit configured to calculate a loss between a current frame and the current labeling frame by comparing the current labeling frame with the current labeling frame estimated by the pattern class estimation unit.

### CROSS-REFERENCE TO RELATED APPLICATION

This application claims priority to and the benefit of Korean Patent Application No. 10-2020-0135456, filed on Oct. 19, 2020, the disclosure of which is incorporated herein by reference in its entirety.

### BACKGROUND

### 1. Field of the Invention

The present invention relates to a segmentation and tracking system and method based on self-learning using video patterns in video and, more particularly, to a segmentation and tracking system based on self-learning in video.

### 2. Discussion of Related Art

Recently, self-learning networks that show performance comparable to fully supervised learning-based networks using a model pre-trained with a dataset composed of an image net are being developed.

Here, the self-learning refers to a technique for learning by directly generating a correct answer label for learning from an image or video.

By using such self-learning, it is possible to perform learning using numerous still images and videos on the Internet without needing to directly label the dataset.

Recently, technologies using self-learning have been developed not only in the field of classifying images but also in the field of video segmentation and tracking.

Among these technologies, FIG. 1 is a configuration block diagram illustrating the conventional video colorization technique.

As illustrated in FIG. 1, video colorization, which quantizes color correction in video and sets the quantized color correction as a classification correct answer and predicts colors of grayscale images in adjacent frames, has been proposed first.

As a result, it is possible to perform segmentation and tracking without using the segmentation and tracking correct answer dataset in the image.

In particular, a very precise labeling operation is required to create a segmented dataset, which requires a great deal of time and labor.

The conventionally proposed video colorization technology enables segmentation and tracking through color reconstruction between adjacent frames in general video without performing separate laborious video segmentation labeling.

Meanwhile, a recently proposed corrFlow technology expands the video colorization technology to simultaneously consider not only the adjacent frames but also the relationship with several frames with a temporal gap and improves the performance by dropping out input images for each color information channel and using the dropped-out images for learning. In addition, the corrFlow technology generates the correct answer label using Lab color information, not RGB images, and makes the generated correct answer label robust to changes in illuminance of an image.

However, the conventional video colorization technology has a problem in that it fails to consider edges or patterns of objects that may be regarded as key features of the segmentation and tracking through the self-learning using only the color information, and the color information may be easily changed due to changes in the surrounding environment such as lighting, even when the Lab color information is used.

### SUMMARY OF THE INVENTION

The present invention is directed to solving the conventional problems and provides a segmentation and tracking system based on self-learning using video patterns in video for solving a problem of a self-learning segmentation and tracking method based on deep learning that has performed self-learning by quantizing basic color information and setting the quantized color information as a classification correct answer.

In addition, the present invention provides a segmentation and tracking system based on self-learning using video patterns in video capable of improving accuracy of segmentation and tracking by setting a classification correct answer in consideration of a pattern instead of color information of an image and performing learning.

The present invention provides a segmentation and tracking system based on self-learning using video patterns capable of increasing pattern quantization efficiency through a classification answer generation technology by using a hash table using a clustering technique or hashing technique to quantize a pattern.

The objects of the present invention are not limited to the above-described effects. That is, other objects that are not described may be obviously understood by those skilled in the art from the claims.

According to an aspect of the present invention, there is provided a segmentation and tracking system based on self-learning using video patterns in video, the segmentation and tracking system including a pattern-based labeling processing unit configured to extract a pattern from a learning image and then perform labeling in each pattern unit and generate a self-learning label in the pattern unit, a self-learning-based segmentation/tracking network processing unit configured to receive two adjacent frames extracted from the learning image and estimate pattern classes in the two frames selected from the learning image, a pattern class estimation unit configured to estimate a current labeling frame through a previous labeling frame extracted from the image labeled by the pattern-based labeling processing unit and a weighted sum of the estimated pattern classes of a previous frame of the learning image, and a loss calculation unit configured to calculate a loss between a current frame and the current labeling frame by comparing the current labeling frame with the current labeling frame estimated by the pattern class estimation unit.

The pattern-based labeling processing unit may include: an image-based pattern extraction unit configured to transmit result values of each filter to which a Walsh-Hadamard kernel is applied for each patch in the learning image, a pattern-based clustering unit configured to perform pattern-based clustering using the transmitted result values of each filter, and a patch unit labeling unit configured to perform labeling in units of patches by allocating a cluster index of a pattern to pattern-based clustered information.

The pattern-based labeling processing unit may use K-means clustering when the labeling is performed in the pattern unit.

The self-learning-based segmentation/tracking network processing unit may estimate pattern classes of the current frame through the weighted sum of the pattern classes of the previous frame by setting similarity of embedded feature vectors as a weight using a deep neural network.

The loss calculation unit may calculate similarity of the estimated classes to labels extracted from a real image by cross-entropy, and train a deep neural network with a result value of the calculated similarity.

According to another aspect of the present invention, there is provided a segmentation and tracking system based on self-learning using video patterns in video, the segmentation and tracking system including: a pattern hashing-based label unit part configured to cluster patterns of each patch in an image with locality sensitive hashing or coherency sensitive hashing, hash the clustered patterns to preserve similarity of high-dimensional vectors, and compare the hashed clustered patterns with indexes of a corresponding hash table to determine the hash table as a correct answer label for self-learning; a self-learning-based segmentation/tracking network processing unit configured to receive two adjacent frames extracted from a learning image and estimate pattern classes in the two frames selected from the learning image; a pattern class estimation unit configured to estimate a current labeling frame through a previous labeling frame extracted from the image labeled by the pattern hashing-based label unit part and a weighted sum of the estimated pattern classes of a previous frame of the learning image; and a loss calculation unit configured to calculate a loss between a current frame and the current labeling frame by comparing the current labeling frame with the current labeling frame estimated by the pattern class estimation unit.

The pattern hashing-based label unit part may include: an image-based pattern extraction unit configured to extract a pattern from a learning-based image, a pattern-based hash function unit configured to apply a hash function to the pattern extracted by the image-based pattern extraction unit using index information of a pattern-based hash table, a pattern-based hash table configured to store the index information corresponding to a code of the hash function, and a patch unit labeling unit configured to label, as a correct answer, classes in which all patches of each image are within a preset range by patch unit labeling.

The pattern-based hash function unit may use, as an input of the hash function, result values of each filter to which a Walsh-Hadamard kernel is applied for each patch.

In the hash table, the index may correspond to the code of the hash function, and similar patches may belong to the same hash table entry.

According to still another aspect of the present invention, there is provided a segmentation and tracking method based on self-learning using a video pattern in video, the segmentation and tracking method including extracting a pattern from a learning image and then performing labeling in each pattern unit and generating a self-learning label in the pattern unit, receiving two adjacent frames extracted from the learning image and estimating pattern classes in the two frames selected from the learning image, estimating a current labeling frame through a previous labeling frame extracted from the labeled image and a weighted sum of the estimated pattern classes of a previous frame of the learning image, and calculating a loss between a current frame and a current labeling frame by comparing the current labeling frame with the current labeling frame estimated through the pattern class estimation unit.

The generation of the label may include: transmitting result values of each filter which to which a Walsh-Hadamard kernel is applied for each patch in the learning image, performing pattern-based clustering using the transmitted result values of each filter, and performing labeling in units of patches by allocating a cluster index of a pattern to pattern-based clustered information.

In the estimating of the pattern class, K-means clustering may be used when the labeling is performed in the pattern unit.

In the estimating of the pattern class, a pattern class of the current frame may be estimated through the weighted sum of the pattern class of the previous frame by setting similarity of embedded feature vectors as a weight using a deep neural network.

In the calculating of the loss, the similarity of the estimated classes to labels extracted from a real image may be calculated by cross-entropy, and a deep neural network may be trained with a result value of the calculated similarity.

The generation of the label may include: extracting a pattern from a learning-based image, applying a hash function to the extracted pattern using index information of a pattern-based hash table, and labeling, as a correct answer, classes in which patches of each image are within a preset range.

In the hash table, an index may correspond to a code of the hash function, and similar patches may belong to the same hash table entry.

According to an embodiment of the present invention, it is possible to solve a problem that a self-learning segmentation and tracking method based on deep learning that has performed self-learning by quantizing basic color information and setting the quantized basic color information as a classification correct answer fails to consider edges or patterns of objects which can be regarded as key features of segmentation and tracking.

In addition, the present invention has the effect of more accurately performing matching between two frames as compared with using a color.

The above-described configurations and operations of the present invention will become more apparent from embodiments described in detail below with reference to the drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a functional block diagram for describing a conventional segmentation and tracking system based on self-learning using color quantization in video;

FIG. 2 is a functional block diagram for describing a segmentation and tracking system based on self-learning using video patterns in video according to an embodiment of the present invention;

FIG. 3 is a reference diagram for describing the segmentation and tracking system based on self-learning using video patterns in video according to the embodiment of the present invention;

FIGS. 4 to 8 are reference diagrams for describing a process of processing a pattern-based labeling processing unit of FIG. 2;

FIG. 9 is a functional block diagram for describing a segmentation and tracking system based on self-learning using video patterns in video according to another embodiment of the present invention;

FIG. 10 is a functional block diagram illustrating a pattern hashing-based label unit part of FIG. 9;

FIG. 11 is a flowchart for describing a segmentation and tracking method based on self-learning using a video pattern in video according to an embodiment of the present invention;

FIG. 12 is a flowchart for describing detailed operations of a label generation operation according to the embodiment of FIG. 11; and

FIG. 13 is a flowchart for describing detailed operations of a label generation operation according to another embodiment of FIG. 11.

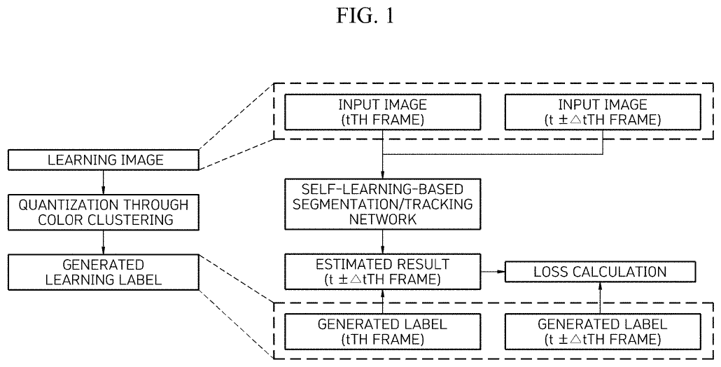

### DETAILED DESCRIPTION OF EXEMPLARY EMBODIMENTS

Various advantages and features of the present invention and methods of accomplishing them will become apparent from the following description of embodiments with reference to the accompanying drawings. However, the present invention is not limited to the embodiments disclosed herein but will be implemented in various forms. The embodiments make contents of the present invention thorough and are provided so that those skilled in the art can easily understand the scope of the present invention. Therefore, the present invention will be defined by the scope of the appended claims. Terms used in the present specification are for describing the embodiments rather than limiting the present invention. Unless otherwise stated, a singular form includes a plural form in the present specification. Components, steps, operations, and/or elements described by terms such as “comprise” and/or “comprising” used in the present invention do not exclude the existence or addition of one or more other components, steps, operations, and/or elements.

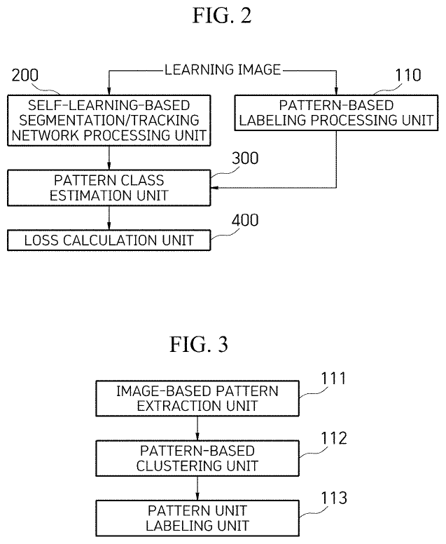

FIG. 2 is a functional block diagram for describing a segmentation and tracking system based on self-learning using video patterns in video according to the present invention. As illustrated in FIG. 2, the segmentation and tracking system based on self-learning using video patterns in video according to the embodiment of the present invention includes a pattern-based labeling processing unit 110, self-learning-based segmentation/tracking network processing unit 200, a pattern class estimation unit 300, and a loss calculation unit 400.

The pattern-based labeling processing unit 110 extracts a pattern from a learning image and then performs labeling in each pattern unit to generate a self-learning label in a pattern unit.

As illustrated in FIG. 3, the pattern-based labeling processing unit 110 of the embodiment of the present invention includes an image-based pattern extraction unit 111, a pattern-based clustering unit 112, and a patch unit labeling unit 113.

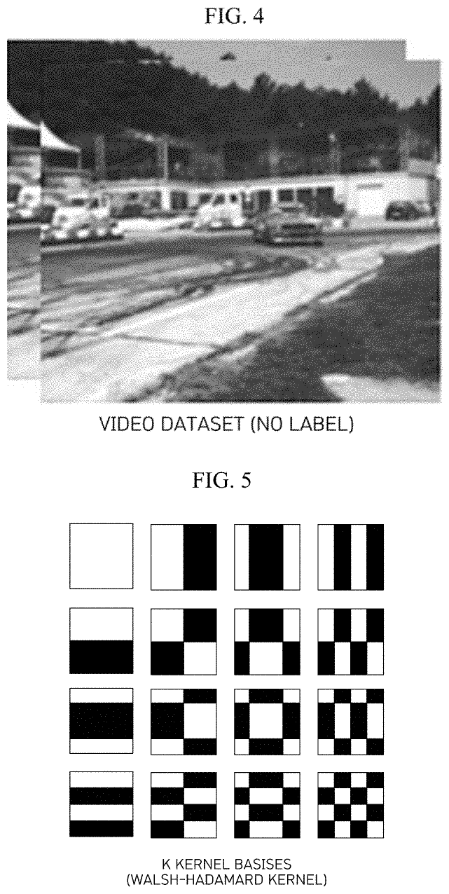

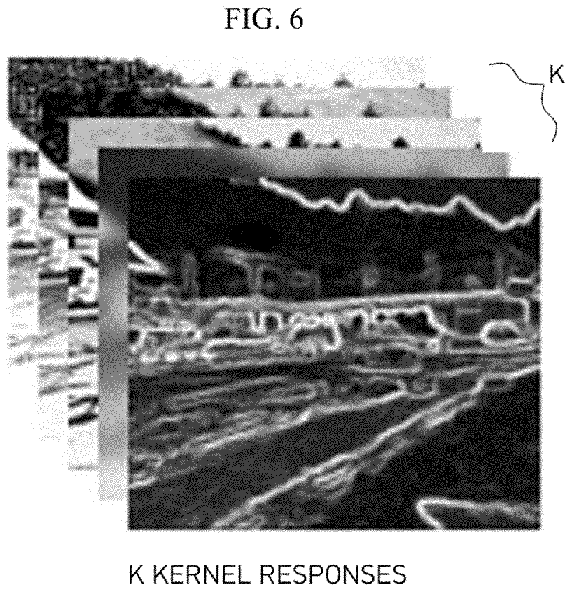

As illustrated in FIG. 4, the image-based pattern extraction unit 111 transmits, to the pattern-based clustering unit 112, result values of each filter illustrated in FIG. 6 to which a Walsh-Hadamard kernel is applied for each patch illustrated in FIG. 5 in a learning image which is a video data set without a label.

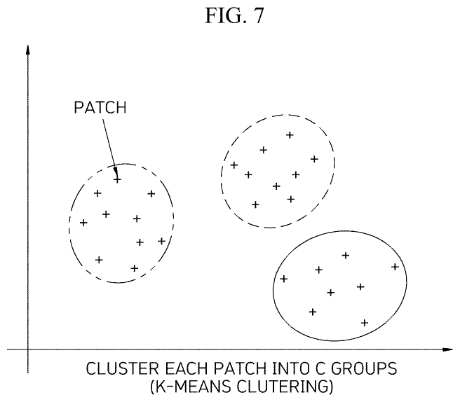

Thereafter, the pattern-based clustering unit 112 performs pattern-based clustering as illustrated in FIG. 7 using the transmitted result values of each filter of FIG. 6.

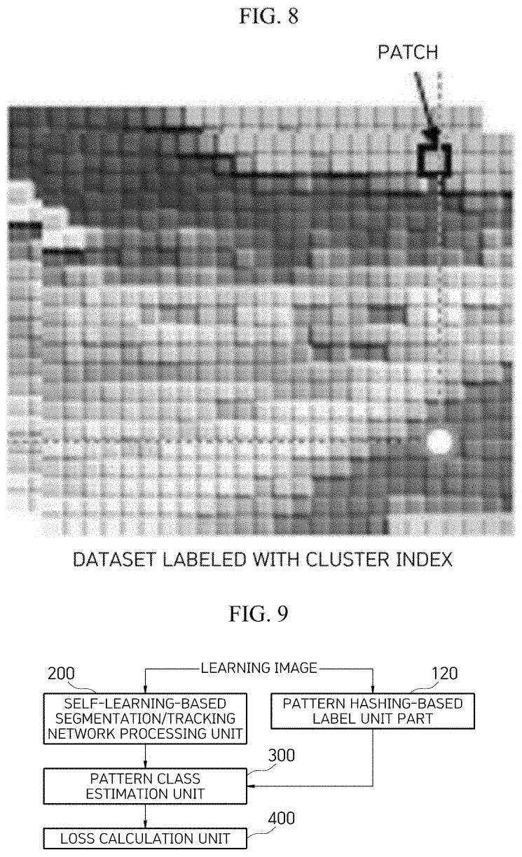

The patch unit labeling unit 113 allocates a cluster index of a pattern to the pattern-based clustering information to perform labeling in units of patches as illustrated in FIG. 8. The pattern-based labeling processing unit 110 may perform segmentation through a patch and may use K-means clustering when the labeling is performed in units of patches.

Then, the self-learning-based segmentation/tracking network processing unit 200 receives two adjacent frames extracted from the learning image and estimates pattern classes in the two frames selected from the learning image. In this case, the self-learning-based segmentation/tracking network processing unit 200 estimates pattern classes of a current frame with a weighted sum of pattern classes of a previous frame by setting similarity of embedded feature vectors as a weight using a deep neural network.

In addition, the pattern class estimation unit 300 estimates a current labeling frame through a previous labeling frame extracted from the learning image labeled by the pattern-based labeling processing unit 110 and the weighted sum of the estimated pattern classes of the previous frame of the learning image estimated by the self-learning-based segmentation/tracking network processing unit 200.

The loss calculation unit 400 calculates a loss between the current frame and the current labeling frame by comparing the current labeling frame with the current labeling frame estimated by the pattern class estimation unit. That is, the loss calculation unit 400 calculates how much the estimated classes are similar to a label extracted from a real image by cross-entropy and trains the deep neural network with a result value of the calculated similarity.

According to an embodiment of the present invention, it is possible to solve a problem that a self-learning segmentation and tracking method based on deep learning that has performed self-learning by quantizing basic color information and setting the quantized basic color information as a classification correct answer fails to consider edges or patterns of objects which may be regarded as key features of segmentation and tracking.

In addition, the present invention has the effect of more accurately performing matching between two frames as compared with using a color.

### Second Embodiment

FIG. 9 is a functional block diagram for describing a segmentation and tracking system based on self-learning using video patterns in video according to another embodiment of the present invention. As illustrated in FIG. 9, the segmentation and tracking system based on self-learning using video patterns in video according to another embodiment of the present invention includes a pattern hashing-based label unit part 120, a self-learning-based segmentation/tracking network processing unit 200, a pattern class estimation unit 300, and a loss calculation unit 400.

The pattern hashing-based label unit part 120 clusters patterns of each patch in an image by locality sensitive hashing or coherency sensitive hashing, hashes the clustered patterns to preserve similarity of high-dimensional vectors, and uses the corresponding hash table as a correct answer label for self-learning. As a result, when the hashing techniques are used, it is possible to quickly cluster the patterns of patches and search for similar patterns.

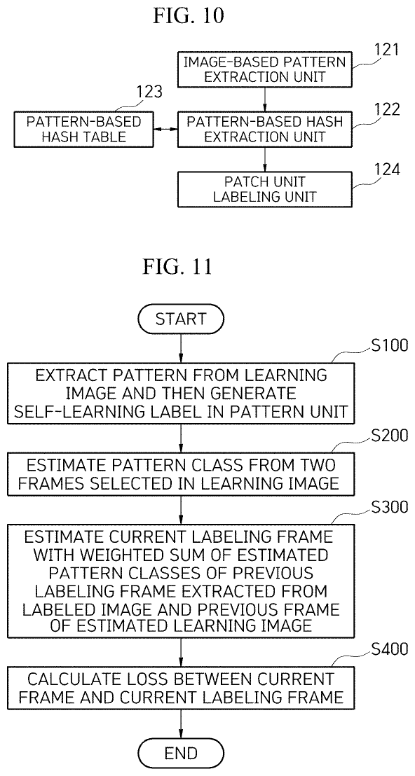

As illustrated in FIG. 10, the pattern hashing-based label unit part 120 includes an image-based pattern extraction unit 121, a pattern-based hash function unit 122, a pattern-based hash table 123, and a patch unit labeling unit 124.

The image-based pattern extraction unit 121 extracts a pattern from a learning-based image.

The pattern-based hash function unit 122 applies a hash function to the pattern extracted by the image-based pattern extraction unit 121 using index information of the pattern-based hash table.

In this case, the pattern-based hash function unit 122 may use, as an input to the image-based pattern extraction unit 121, result values of each filter to which a Walsh-Hadamard kernel is applied for each patch.

The pattern-based hash table 123 stores index information corresponding to codes of the hash function. Here, the indexes of each hash table 301 correspond to the codes of the hash function, and similar patches belong to the same hash table entry. Therefore, the indexes of the hash table are set as correct answer classes, and the number of classes becomes a size (K) of the hash table.

The patch unit labeling unit 124 labels, as a correct answer, classes in which all the patches of each image are within the K range by patch unit labeling.

The self-learning-based segmentation/tracking network processing unit 200 receives two adjacent frames extracted from the learning image and estimates pattern classes in the two frames selected from the learning image. In this case, the self-learning-based segmentation/tracking network processing unit 200 estimates pattern classes of a current frame with a weighted sum of pattern classes of a previous frame by setting similarity of embedded feature vectors as a weight using a deep neural network.

In addition, the pattern class estimation unit 300 estimates a current labeling frame through the previous labeling frame extracted from the image labeled by the pattern hashing-based label unit part 120 and a weighted sum of the estimated pattern classes of the previous frame of the learning image.

The loss calculation unit 400 calculates a loss between the current frame and the current labeling frame by comparing the current labeling frame with the current labeling frame estimated by the pattern class estimation unit. That is, the loss calculation unit 400 calculates how much the estimated classes are similar to a label extracted from a real image by cross-entropy and trains the deep neural network with a result value of the calculated similarity. Such a learning loss calculation unit 400 may be performed using a correct answer label generated using a pattern-based hashing table.

According to another embodiment of the present invention, there is an effect of increasing pattern quantization efficiency through a technology of generating a classification correct answer using a hash table using a hashing technique.

Hereinafter, a segmentation and tracking method based on self-learning using a video pattern in video according to an embodiment of the present invention will be described with reference to FIG. 11.

First, the pattern is extracted from the learning image and the labeling is performed in each unit of patterns to generate the self-learning label in units of patterns (S100).

Two adjacent frames extracted from the learning image are received, and the pattern classes are estimated in the two frames selected from the learning image (S200). Here, in the estimating of the pattern classes, the pattern class of the current frame may be estimated through the weighted sum of the pattern class of the previous frame by setting the similarity of the embedded feature vectors as the weight using the deep neural network.

The current labeling frame is estimated through the previous labeling frame extracted from the labeled image and the weighted sum of the estimated pattern classes of the previous frame of the learning image (S300). Here, in the estimating of the pattern classes, K-means clustering may be used when the labeling is performed in units of patterns.

The loss between the current frame and the current labeling frame is calculated by comparing the current labeling frame with the current labeling frame estimated by the pattern class estimation unit (S400).

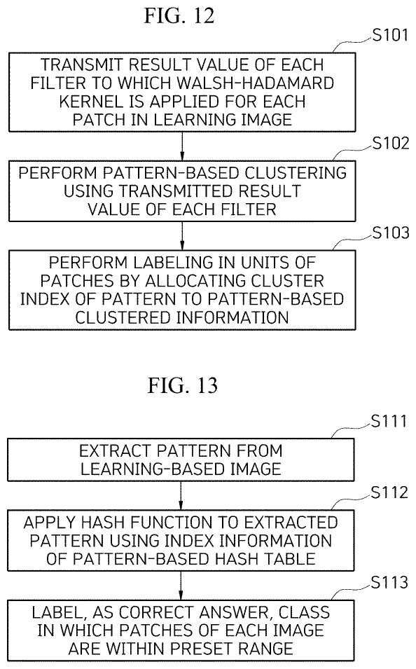

The generation of the label (S100) according to the embodiment of the present invention will be described with reference to FIG. 12.

The result values of each filter to which the Walsh-Hadamard kernel is applied for each patch in the learning image are transmitted (S101).

The pattern-based clustering is performed using the transmitted result values of each filter (S102).

Next, the labeling is performed in units of patches by allocating a cluster index of a pattern to the pattern-based clustered information (S103).

In the calculation of the loss (S400), the similarity of the estimated classes to the labels extracted from the real image is calculated by cross-entropy, and the deep neural network is trained with the result value of the calculated similarity.

The generation of the label (S100) according to another embodiment of the present invention will be described with reference to FIG. 13.

First, the pattern is extracted from the learning-based image (S111).

The hash function is applied to the extracted pattern using the index information of the pattern-based hash table (S112). Here, in the hash table, the index may correspond to the code of the hash function, and similar patches may belong to the same hash table entry.

Thereafter, the classes in which all the patches of each image are within a preset range are labeled as the correct answer by the patch unit labeling.

### Third Embodiment

In another embodiment of the present invention, a method of predicting a self-learning-based segmentation/tracking network using pattern hashing will be described.

First, a test learning loss calculation unit 800 segments a mask of the next frame by using a mask of an object to be tracked labeled in a first frame (S1010).

Then, the self-learning-based segmentation/tracking network 200 extracts feature maps for each image from a previous frame input image 701 and a current frame input image 702 of the test image (S1020).

Thereafter, a label of an object segmentation mask in the current frame is estimated by a weighted sum of previous frame labels using similarity of the feature maps of the two frames (S1030).

Next, the estimated object segmentation label of the current frame is used as a correct answer label in the next frame to be recursively used for learning for subsequent frames (S1040).

According to another embodiment of the present invention, using the same process as the existing color-based segmentation/tracking network using self-learning, there is an effect that it is possible to predict and learn the object segmentation of the self-learning-based segmentation/tracking network during testing.

A program for extracting an image-based pattern, a pattern-based hash function program, and a pattern-based hash table are stored in a memory, and a processor executes the program stored in the memory.

In this case, the memory 10 collectively refers to a nonvolatile storage device and a volatile storage device that keeps stored information even when power is not supplied.

For example, the memory 10 may include NAND flash memories such as a compact flash (CF) card, a secure digital (SD) card, a memory stick, a solid-state drive (SSD), and a micro SD card, magnetic computer storage devices such as a hard disk drive (HDD), and optical disc drives such as a compact disc (CD)-read-only memory (ROM) and a digital video disk (DVD)-ROM, and the like.

On the other hand, the segmentation and tracking system based on self-learning using video patterns in video stores the program for extracting the image-based pattern, the pattern-based hash function program, and the pattern-based hash table, and the processor may be implemented in the form in which the program stored in the memory is installed in one server computer and interoperates.

For reference, the components according to the embodiment of the present invention may be implemented in software or in a hardware form such as a field programmable gate array (FPGA) or an application specific integrated circuit (ASIC) and may perform predetermined roles.

However, “components” are not limited to software or hardware, and each component may be configured to be in an addressable storage medium or configured to reproduce one or more processors.

Accordingly, for example, the components include components such as software components, object-oriented software components, class components, and task components, processors, functions, attributes, procedures, subroutines, segments of a program code, drivers, firmware, a microcode, a circuit, data, a database, data structures, tables, arrays, and variables.

Components and functions provided within the components may be combined into a smaller number of components or further separated into additional components.

In this case, it can be appreciated that each block of a processing flowchart and combinations of the flowcharts may be executed by computer program instructions. Since these computer program instructions may be installed in a processor of a general computer, a special purpose computer, or other programmable data processing apparatuses, these computer program instructions running through the processing of the computer or the other programmable data processing apparatuses create a means for performing functions described in the block(s) of the flowchart. Since these computer program instructions may also be stored in a computer usable or computer readable memory of a computer or other programmable data processing apparatuses in order to implement the functions in a specific scheme, the computer program instructions stored in the computer usable or computer readable memory can also produce manufacturing articles including an instruction means for performing the functions described in the block(s) of the flowchart. Since the computer program instructions may also be installed in the computer or the other programmable data processing apparatuses, the instructions perform a series of operation steps on the computer or the other programmable data processing apparatuses to create processes executed by the computer, thereby running the computer, or the other programmable data processing apparatuses may also provide operations for performing the functions described in the block(s) of the flowchart.

In addition, each block may indicate some of modules, segments, or codes including one or more executable instructions for executing a specific logical function(s). Further, it is to be noted that functions described in the blocks occur regardless of a sequence in some alternative embodiments. For example, two blocks that are consecutively shown may in fact be simultaneously performed or performed in a reverse sequence depending on corresponding functions.

In this case, the term “˜ unit” used in this example embodiment refers to software or hardware components such as an FPGA or an ASIC, and the “˜ unit” performs certain roles. However, “˜ unit” is not limited to the software or the hardware. “˜ unit” may be configured to be in an addressable storage medium or may be configured to reproduce one or more processors. Therefore, as an example, “˜ unit” includes components such as software components, object-oriented software components, class components and task components, processes, functions, attributes, procedures, subroutines, segments of a program code, drivers, firmware, a microcode, a circuit, data, a database, data structures, tables, arrays, and variables. Components and functions provided within “˜ units” may be combined with a smaller number of components and “˜ units” or be further separated from additional components and “˜ units”. Furthermore, components and “˜ units” may be implemented to reproduce one or more central processing units (CPUs) in a device or a security multimedia card.

Heretofore, the configuration of the present invention has been described in detail with reference to the accompanying drawings, but this is only an example, and thus, can be variously modified and changed within the scope of the technical idea of the present invention by those skilled in the art to which the present invention belongs. Accordingly, the scope of protection of the present invention should not be limited to the above-described embodiment and should be defined by the description of the claims below.

What is claimed is:

1. A segmentation and tracking system based on self-learning using video patterns in video, the segmentation and tracking system comprising:
a pattern-based labeling processing unit configured to extract a pattern from a learning image and then perform labeling in each pattern unit and generate a self-learning label in the pattern unit;
a self-learning-based segmentation/tracking network processing unit configured to receive two adjacent frames extracted from the learning image and estimate pattern classes in the two frames selected from the learning image;
a pattern class estimation unit configured to estimate a current labeling frame through a previous labeling frame extracted from the image labeled by the pattern-based labeling processing unit and a weighted sum of the estimated pattern classes of a previous frame of the learning image; and
a loss calculation unit configured to calculate a loss between a current frame and the current labeling frame by comparing the current labeling frame with the current labeling frame estimated by the pattern class estimation unit.

2. The segmentation and tracking system of claim 1, wherein the pattern-based labeling processing unit includes:
an image-based pattern extraction unit configured to transmit result values of each filter to which a Walsh-Hadamard kernel is applied for each patch in the learning image;
a pattern-based clustering unit configured to perform pattern-based clustering using the transmitted result values of each filter; and
a patch unit labeling unit configured to perform labeling in units of patches by allocating a cluster index of a pattern to pattern-based clustered information.

3. The segmentation and tracking system of claim 2, wherein the pattern-based labeling processing unit uses K-means clustering when the labeling is performed in the pattern unit.

4. The segmentation and tracking system of claim 1, wherein the self-learning-based segmentation/tracking network processing unit estimates pattern classes of the current frame through the weighted sum of the pattern classes of the previous frame by setting similarity of embedded feature vectors as a weight using a deep neural network.

5. The segmentation and tracking system of claim 1, wherein the loss calculation unit calculates similarity of the estimated classes to labels extracted from a real image by cross-entropy, and trains a deep neural network with a result value of the calculated similarity.

6. A segmentation and tracking system based on self-learning using video patterns in video, the segmentation and tracking system comprising:
a pattern hashing-based label unit part configured to cluster patterns of each patch in an image with locality sensitive hashing or coherency sensitive hashing, hash the clustered patterns to preserve similarity of high-dimensional vectors, and compare the hashed clustered patterns with indexes of a corresponding hash table to determine the hash table as a correct answer label for self-learning;
a self-learning-based segmentation/tracking network processing unit configured to receive two adjacent frames extracted from a learning image and estimate pattern classes in the two frames selected from the learning image;
a pattern class estimation unit configured to estimate a current labeling frame through a previous labeling frame extracted from the image labeled by the pattern hashing-based label unit part and a weighted sum of the estimated pattern classes of a previous frame of the learning image; and
a loss calculation unit configured to calculate a loss between a current frame and the current labeling frame by comparing the current labeling frame with the current labeling frame estimated by the pattern class estimation unit.

7. The segmentation and tracking system of claim 6, wherein the pattern hashing-based label unit part includes:
an image-based pattern extraction unit configured to extract a pattern from a learning-based image;
a pattern-based hash function unit configured to apply a hash function to the pattern extracted by the image-based pattern extraction unit using index information of a pattern-based hash table;
a pattern-based hash table configured to store the index information corresponding to a code of the hash function; and
a patch unit labeling unit configured to label, as a correct answer, classes in which all patches of each image are within a preset range by patch unit labeling.

8. The segmentation and tracking system of claim 7, wherein the pattern-based hash function unit uses, as an input of the hash function, result values of each filter to which a Walsh-Hadamard kernel is applied for each patch.

9. The segmentation and tracking system of claim 7, wherein, in the hash table, the index corresponds to the code of the hash function, and similar patches belong to the same hash table entry.

10. A segmentation and tracking method based on self-learning using a video pattern in video, the segmentation and tracking method comprising:
extracting a pattern from a learning image and then performing labeling in each pattern unit and generating a self-learning label in the pattern unit;
receiving two adjacent frames extracted from the learning image and estimating pattern classes in the two frames selected from the learning image;
estimating a current labeling frame through a previous labeling frame extracted from the labeled image and a weighted sum of the estimated pattern classes of a previous frame of the learning image; and
calculating a loss between a current frame and a current labeling frame by comparing the current labeling frame with the current labeling frame estimated through the pattern class estimation unit.

11. The segmentation and tracking method of claim 10, wherein the generating of the label includes:
transmitting result values of each filter which to which a Walsh-Hadamard kernel is applied for each patch in the learning image;
performing pattern-based clustering using the transmitted result values of each filter; and
performing labeling in units of patches by allocating a cluster index of a pattern to pattern-based clustered information.

12. The segmentation and tracking method of claim 11, wherein, in the estimating of the pattern class, K-means clustering is used when the labeling is performed in the pattern unit.

13. The segmentation and tracking method of claim 10, wherein, in the estimating of the pattern class, a pattern class of the current frame is estimated through the weighted sum of the pattern classes of the previous frame by setting similarity of embedded feature vectors as a weight using a deep neural network.

14. The segmentation and tracking method of claim 10, wherein, in the calculating of the loss, similarity of the estimated classes to labels extracted from a real image is calculated by cross-entropy, and a deep neural network is trained with a result value of the calculated similarity.

15. The segmentation and tracking method of claim 10, wherein the generation of the label includes:
extracting a pattern from a learning-based image;
applying a hash function to the extracted pattern using index information of a pattern-based hash table; and
labeling, as a correct answer, classes in which patches of each image are within a preset range by patch unit labeling.

16. The segmentation and tracking method of claim 15, wherein, in the hash table, an index corresponds to a code of the hash function, and similar patches belong to the same hash table entry.
